(19) United States
(12) Patent Application Publication
(10) Pub. No.: US 2024/0166441 A1
(43) Pub. Date: May 23, 2024

(54) AUTOMATED GARMENT STORAGE AND RETRIEVAL SYSTEM

(71) Applicant: PLANIFORM CONVEYORS INC., Terrebonne (CA)

(72) Inventors: Gabriel ST-JEAN, Lorraine (CA); Dany BOUCHARD, Terrebonne (CA); Charles D’AMOURS-LAVOIE, Terrebonne (CA); Christophe BOISCLAIR, Saint-Roch-de-l’Achigan (CA); Dominic GOSSELIN, Mascouche (CA); Francis FORTIER, St-Eustache (CA); Guillaume PAQUET, Terrebonne (CA); Simon LAVIGNE, Terrebonne (CA); Pierre GIBEAULT, Terrebonne (CA); Jess WALLACE, Terrebonne (CA)

(21) Appl. No.: 18/551,992

(22) PCT Filed: Mar. 22, 2022
(86) PCT No.: PCT/CA2022/050428

§ 371 Date: Sep. 22, 2023

Related U.S. Application Data
(60) Provisional application No. 63/164,170, filed on Mar. 22, 2021.

(51) Int. Cl. B65G 1/137; B65G 1/04

(52) U.S. Cl. CPC B65G 1/137; B65G 1/0457; B65G 1/0492

(57) ABSTRACT

An automated storage and retrieval system for managing the contents of a garment-on-hanger (GOH) storage area includes an autonomous “transporter” that is configured to transport GOH items between the processing area and the storage area and an automated “forager” that can hold and manipulate a GOH item to place it in, or retrieve it from, a storage location. The transporter and forager work together to automatically store and retrieve GOH items, riding on a system of rails and moving between vertical levels on an elevator. Standardized “mother hooks” are used from which the GOH items hang, which may be held by a picker arm of the forager, and inserted into slots in storage areas and on the transporter. Blades on the forager may be inserted to either side of a GOH item to allow adjacent GOH items to be displaced during manipulation.

### BACKGROUND OF THE INVENTION

### Field of the Invention

This invention relates generally to the field of inventory storage and retrieval and, more particularly, to the storage and retrieval of garments on hangers and/or accessories, often stored in bags.

### Description of the Related Art

In the garment industry, articles such as shirts, jackets or pants are frequently transported and stored on hangers, and are referred to by the acronym “GOH”, which stands for “garment-on-hanger.” The large-scale handling of GOH items typically requires an efficient means of storing and retrieving them in warehouses or other storage areas. Overhead conveyors are frequently used in different business locales to transport GOH items to and from various storage locations. However, a significant amount of manpower is still required for properly handling a large number of GOH items.

Warehouses exist for which overhead conveyors are combined with storage racks that may be used to store GOH items in a logical, predetermined manner. Conveyors are designed to transport the items to and from the locations of the storage racks, where workers remove items from the conveyors and place them in a designated storage area, or remove items from a designated storage area and place them on a garment conveyor. While effective, this type of system requires human labor at several different stages of the storage and retrieval process, which represents a significant cost in the GOH management, and potentially limits the efficiency of the system.

### SUMMARY OF THE INVENTION

In accordance with the present invention, an automated storage and retrieval system is provided for managing the contents of a storage area in which garment-on-hanger (GOH) items are stored. The system includes an autonomous transport vehicle (also referred to herein as a “transporter”) that is configured for automated movement between a processing location away from the storage area and a predetermined region of the storage area, and that transports GOH items between the processing area and the storage area. The system also includes an automated storage/retrieval apparatus (also referred to herein as a “forager”) that can hold and manipulate a GOH item. The storage/retrieval apparatus is configured to place a GOH item transported from the processing area in any of a plurality of designated storage locations of the storage area, and to retrieve a GOH item from any of a plurality of designated storage locations in the storage area that is subsequently transported to the processing area.

In the exemplary embodiment, the storage/retrieval apparatus and the transport vehicle are separate apparatuses, with the storage/retrieval apparatus being configured to remove GOH items from the transport vehicle and place them in the designated storage locations, and to remove GOH items from the designated storage locations and place them on the transport vehicle. The transport vehicle may be only one of a plurality of transport vehicles that operate simultaneously in the system. Similarly, the storage/retrieval apparatus may be only one of a plurality of storage/retrieval apparatuses that operate simultaneously in the system.

The storage area may have multiple vertical levels with designated storage locations on each level. In such a system, an elevator may be provided that is configured to receive the transport vehicle or the storage/retrieval apparatus, and is configured to move either or both of them between the different vertical levels. The system may also use standardized mounting hooks (also referred to herein as “mother hooks”) from which the hangers of the GOH items are suspended. In the exemplary embodiment, the storage/retrieval apparatus is configured to hold the GOH items by the mounting hooks. The mounting hooks may also be used to suspend GOH items at each of the designated storage locations, and may be used to suspend the GOH items on the transport vehicle.

In the exemplary embodiment, the transport vehicle has one or more batteries and a wheeled base powered by at least one electric motor. In this embodiment, the storage/retrieval apparatus is also an autonomous vehicle capable of independent movement, and may also have one or more batteries and a wheeled base powered by at least one electric motor. Thus, both the transport vehicle and the storage/retrieval apparatus may move independently throughout the system, and be transported up and down between levels via the elevator. In the exemplary embodiment there is also at least one recharging location that is accessible to the transport vehicle and the storage/retrieval apparatus, and at which the transport vehicle or the storage/retrieval apparatus may automatically engage with an electrical charging system to recharge its on-board battery or batteries. A system of rails may be distributed through the storage area and the transport vehicle and storage/retrieval apparatus may travel exclusively on the rails.

In the exemplary embodiment, the storage/retrieval apparatus has a head from which extends a picker arm with which a GOH item is held and manipulated. The head may be raised and lowered relative to the rest of the storage/retrieval apparatus, and may be rotatable relative to the rest of the storage/retrieval apparatus. The picker arm may also be configured so that it may be extended and retracted relative to the head. If the system uses standardized mounting hooks, as described above, the picker arm may include a receptacle at its distal end in which one of the mounting hooks may be held. The storage/retrieval apparatus may also include a pair of blades that extend from the head, the blades being movable relative to each other in a horizontal direction and relative to the head in a vertical direction. The blades may be inserted to either side of a chosen one of the designated storage locations, adjusted to a desired height and moved apart from each other so as to displace GOH items on either side of the chosen storage area away from it. A GOH item may then be placed in the chosen storage area, or retrieved from the chosen storage area, with minimal interference from GOH items in the adjacent storage areas.

In the exemplary embodiment, GOH items transported by the transport vehicle are suspended therefrom by their hangers. Compression members may be provided with the transport vehicle that extend in a first horizontal direction to either side of a GOH item being transported, and the compression members may then be moved closer to each other in a second horizontal direction perpendicular to the first horizontal direction so as to compress the GOH item being transported therebetween. This minimizes inertial movement of the GOH item relative to the transport vehicle during transport. If standardized hooks are being used, as described above, the transport vehicle may also include a hook tray configured to receive a plurality of the standardized hooks to allow multiple GOH items to be suspended from the hook tray and reside adjacent to one another during transport.

### BRIEF DESCRIPTION OF THE DRAWINGS

FIG. 1 is a schematic overview of an automated GOH storage and retrieval system according to the present invention.

FIG. 2 is a schematic depiction of a loading/unloading station used with the system of FIG. 1.

FIG. 2A is an isolated view of a panel of the loading/unloading station of FIG. 2 having indicator lights visible to a system operator.

FIG. 3 is a schematic depiction of an elevator for moving transporters and foragers between different vertical levels of the system of FIG. 1.

FIG. 3A is an isolated view of a connection between a platform and frame of the elevator of FIG. 3.

FIG. 4A is a schematic perspective view of a cart used as the base for autonomous vehicles of the system of FIG. 1.

FIG. 4B is a schematic top view of the cart shown in FIG. 4A.

FIG. 5A is a schematic perspective view of a transporter for use with the system of FIG. 1.

FIG. 5B is a schematic perspective view of a compression bar mechanism used with the transporter of FIG. 5A

FIG. 5C is a schematic perspective view of a mother hook tray that can be used with the transporter of FIG. 5A and that has a lockable camshaft system.

FIG. 5D is an isolated side view of the camshaft system of FIG. 5C shown in a locked position.

FIG. 5E is an isolated side view of the camshaft system of FIG. 5C shown in an unlocked position.

FIG. 6A is a perspective view of a mother hook used for handling GOH items in the system of FIG. 1.

FIG. 6B is a front view of the mother hook shown in FIG. 6A.

FIG. 6C is a side view of the mother hook shown in FIG. 6A.

FIG. 6D is a perspective view of a mother hook like that shown in FIG. 6A, in which the mother hook is attached to a mother hook tray and supports a garment hanger.

FIG. 7A is a schematic perspective view of a forager used with the system of FIG. 1.

FIG. 7B is a schematic perspective view of a top portion of the forager of FIG. 7A in a first position of a picking sequence in which the forager engages with a mother hook from which a GOH item is suspended.

FIG. 7C is a schematic perspective view of an isolated portion of the forager of FIG. 7B, showing the mechanism for controlling the forager head.

FIG. 7D is a schematic front view of the forager head shown in FIG. 7C.

FIG. 7E is a schematic perspective view from the underside of an isolated portion of the forager head shown in FIG. 7C, showing a garment picker arm used for placing and retrieving GOH items.

FIG. 7F is an isolated perspective view of the garment picker arm shown in FIG. 7E.

FIG. 7G is an isolated perspective view of a side portion and blade of the forager head of FIG. 7C.

FIG. 8A is a schematic view of a first position of the garment picker arm of FIG. 7E during a picking sequence, in which the picker arm is approaching a rack from which a GOH item is suspended.

FIG. 8B is a schematic view of a second position of the garment picker arm of FIG. 8A in which the picker arm is making contact with the rack.

FIG. 8C is a schematic view of a third position of the garment picker arm of FIG. 8A in which the picker arm extension of the picker arm is engaging a mother hook of the rack from which the GOH item is suspended.

FIG. 8D is a schematic view of a fourth position of the garment picker arm of FIG. 8A in which the mother hook engaged by the picker arm extension in FIG. 8C has been lifted.

FIG. 8E is a schematic view of a fifth position of the garment picker arm of FIG. 8A in which the picker arm extension holding the mother hook has been retracted along the picker arm.

FIG. 9A is a schematic perspective view of a second position of the picking sequence of the forager shown in FIG. 7B.

FIG. 9B is a schematic perspective view of a third position in the picking sequence of the forager of FIG. 7B.

FIG. 9C is a schematic perspective view of a fourth position in the picking sequence of the forager of FIG. 7B.

### DETAILED DESCRIPTION

### Overview

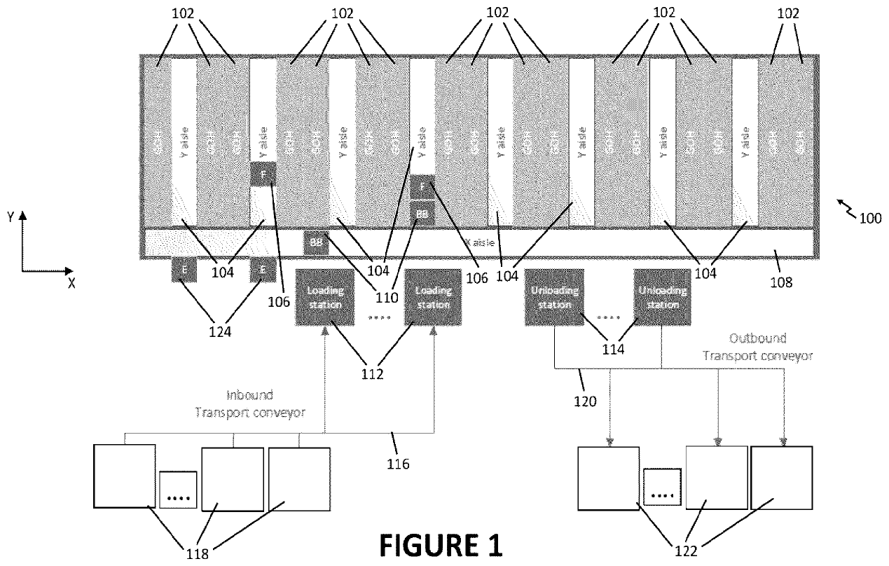

FIG. 1 is a schematic top view of an exemplary embodiment of the automated garment storage and retrieval system, which is particularly appropriate for managing the large-scale warehousing of garments on hangers (GOH). A storage area 100 consists of a series of storage rows 102 oriented in the y-direction (as so identified in the figure), each of which has one or more supports from which GOH items to be stored may be suspended. Those skilled in the art will understand that there may be more or fewer storage rows 102 than are shown in FIG. 1, with the total number of rows being dependent on the specific application. As discussed in more detail below, the storage rows shown in the top view of FIG. 1 also represent but a single vertical level, and the storage area 100 in the exemplary embodiment consists of multiple levels, each having a storage area similar to that shown in the figure.

Each of the storage rows 102 borders on an aisle 104 that runs parallel to at least one storage row and, typically, has a storage row to either side of it. Because the aisles 104 are oriented in the y-direction (relative to the coordinate axes shown in the figure), they are referred to herein as “y-aisles.” The y-aisles 104 provide access to the storage rows 102 for depositing and retrieving garments stored therein. Since storage rows need only be accessible on one side, much of the storage area consists of pairs of directly adjacent storage rows, with the storage row pairs being separated by a y-aisle from other storage rows. The y-aisles are arranged to permit the automated travel of any one of a plurality of autonomous vehicles, such as transporters 110 that move GOH items throughout the system, and foragers 106, which operate to selectively place garments on hangers in predetermined locations on a support of a particular storage row 102, or to retrieve garments on hangers from particular locations in a storage row. The transporters 110 and foragers 106 are described in greater detail hereinafter.

In the exemplary embodiment, communication with the transporters 110 and foragers 106 will be via a localized Wi-Fi network using a TCP/IP protocol, although other communication schemes are within the scope of the invention. Centralized software control may use a node system that includes a number of predetermined locations that can be occupied by a transporter 110 or a forager 106, each location having a unique identification using, for example, a fixed coordinate system. Traffic control is aided by a node reservation system that allows one of the predetermined locations to be reserved by a vehicle that will then move to that location. Once a vehicle departs from a node, that location is released and is made available to other vehicles. It will be understood that the vehicles can also occupy other locations as necessary since, for example, a forager may need to occupy many different positions adjacent to storage locations that are to be accessed.

Access to the y-aisles 104 is provided by a perpendicular x-aisle 108, along which transporters 110 and foragers 106 may travel to any of the y-aisles 104 of the storage area 100. Like the foragers 106, the transporters 110 are autonomous vehicles adapted to travel within a predefined area, although the transporters 110 lack the garment handling capabilities of the foragers 106, as their function is transportation only. Rather, the transporters 110 function to bring garments between the storage rows and station or stations used for loading and unloading garments to be stored in, or retrieved from, the storage area. The system may use a common loading/unloading station 112 that is for both loading and unloading of GOH items, or multiple stations 112 that may be separately dedicated to loading and unloading. FIG. 1 shows multiple loading/unloading stations 112 and, in the present embodiment, the loading/unloading stations 112 are identical, although it would also be possible to have loading and unloading stations with different configurations. Those skilled in the art will understand that other arrangements of loading/unloading stations may also be possible.

In the exemplary embodiment, the loading/unloading stations 112 are manned by human employees that oversee the loading and unloading operations, either manually or with the assistance of garment handling equipment. However, it will be understood that the use of a fully automated loading or unloading station is also within the scope of the invention. In the embodiment shown, the stations 112 are dedicated to loading incoming garments via a conventional GOH transport conveyor 116, the garments being placed thereon at one or more induction stations 118. Similarly, garments received at the stations 112 dedicated to unloading are delivered via a conventional GOH transport conveyor 120 to one or more packout stations 122. The use of inbound and outbound systems is, however, optional, and the loading and unloading operations may use a common station. Morever, the system is equally adapted to garments being transported to and from the loading/unloading stations 112 manually, such as on a rolling garment rack.

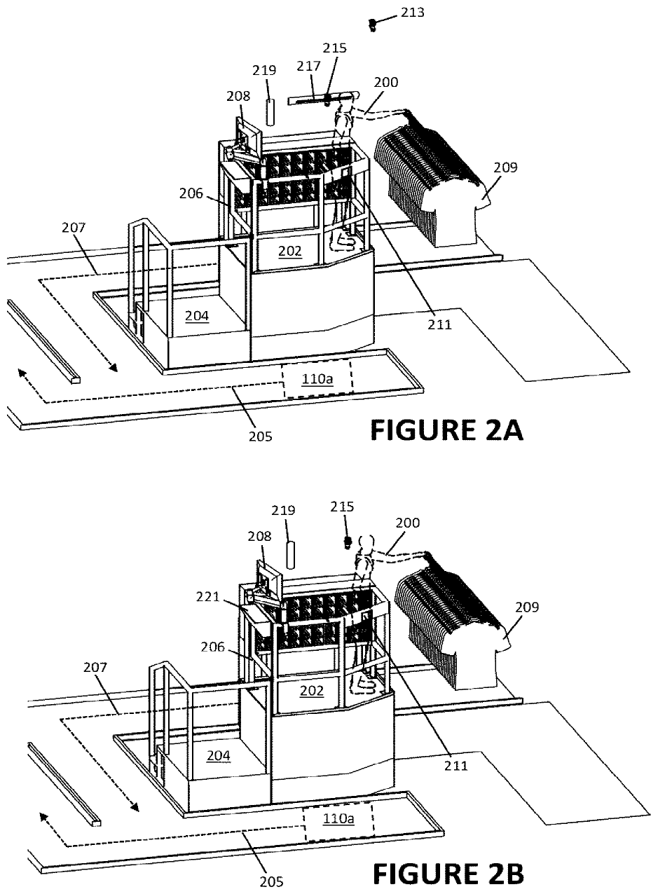

An example of a typical loading/unloading station 112 is shown schematically in FIG. 2. As shown, a human operator 200 stands on an elevated platform 202 accessible by stairs 204 or some other means. The operator 200 is surrounded by a protective railing 206, and has access to a display monitors 208 which provide information regarding the GOH items (not shown) suspended from hangers 209 that are loaded onto a transporter 110 which, when parked at the spot 110a shown in the figure adjacent to the platform 202, will have its top rail at a convenient height for allowing the operator 200 to place hangers 209 holding the GOH items thereupon. In the exemplary embodiment, the transporters 110 and foragers 106 each rest on a cart that provides the necessary locomotion, and the carts ride on rails 111 that are distributed throughout the system area. This rail system is discussed in more detail below.

The platform 202 is arranged so that the transporters 110 arrive at loading/unloading location 110a and, for a loading operation, an inbound conveyor 116 (not shown in FIG. 2) transports GOH items to a different side of the platform. As mentioned above, it is also possible to omit the use of an inbound conveyor and to transport the GOH items to the loading station in another manner, such as by manually transporting them, e.g., with a rolling garment rack. Thus, while the present embodiment discusses the transfer of GOH items from an inbound conveyor to a transporter, those skilled in the art will understand that other embodiments may involve the operator transferring the GOH items from a different structure to the transporter. The height of the conveyor 116 is such that, for a human operated loading operation such as that shown, the position of the inbound garments on the transport conveyor relative to the arrival location 110a of the transporters 110 is ergonomically advantageous to minimize operator fatigue. The platform 202 may also be configured to allow it to be raised or lowered, to be best adapted to the needs of a particular operator.

The arriving GOH items must be loaded onto a transporter, which may be accomplished in different ways, but which will typically include mating each GOH item with a standardized “mother hook.” In the present embodiment, the operator has a supply of mother hooks and takes one, before selecting a GOH item and hooking its hanger into a receiving aperture of the mother hook. The mother hook is then scanned by scanner 211 which, in the exemplary embodiment, is a camera/barcode scanner (although other scanning means may also be used). Each GOH item also has a unique identification component which, in this case, is a visible tag with a barcode that uniquely identifies it, and scanning the GOH item after scanning the mother hook “marries” them together in the system storage records. When a GOH item is scanned, the system determines a proper location for storing it on the transporter, and a visual indication means is used to identify that location to the operator, who places the garment in the designated location, as discussed in more detail below. The process then continues until the maximum number of GOH items have been loaded on the transporter, at which time the transporter is instructed to depart.

A confirmation camera 215 may also be used and, in this embodiment, is mounted on a support structure located adjacent to a “confirmation” position 110b at which a transporter 110 pauses for a confirmation scan. In the embodiment shown in FIG. 2, a pair of confirmation cameras 215 is used to provide a wider scanning range, but those skilled in the art will understand that any number of cameras may be used as appropriate to the specific application. The cameras 215 observe the positioning of the GOH items on the transporter, and verify that they are in the proper locations. Thus, once the transporter is fully loaded, the control system instructs it to depart to deliver the GOH items to their appropriate destinations, and the transporter pauses at the confirmation position 110b for item verification. Upon successful verification, the transporter then continues to its destination.

Often, another empty transporter will be waiting during the loading or unloading of a transporter located at loading/unloading position 110a, and will be ready to move to the loading/unloading position 110a once the last transporter to be loaded has departed. To facilitate the flow of transporter traffic, a waiting area 110c may be provided that is adjacent to the loading/unloading position but not in a position to obstruct the movement of the departing transporter 110. From the waiting area 110c, the next transporter can arrive quickly at the loading/unloading position 110a. A tower light 219 is also present, and may be illuminated different colors (e.g., green, yellow and red) to provide general status information to the operator. For example, illuminating the tower light 219 green might indicate to the operator that loading may proceed, while illuminating the tower light 219 red might indicate that a malfunction has occurred. Those skilled in the art will understand that such an indicator light is optional, and may be used to indicate different conditions according to the specific application in question.

To aid operator 200 in placing GOH items on the transporter, the loading/unloading station is configured with a set of LED indicators on the panel 207 positioned in front of the operator during a loading operation. The operation of the LED indicators is shown in more detail in FIG. 2A. When a transporter is located at loading/unloading position 110a, its mother hook tray 512 aligns with an opening in the panel 207 such that the mother hook retaining slots are directly in the operator's line of vision. While FIG. 2A shows hangers 209 suspended from mother hooks located on the transporter, it will be understood that, upon arrival of the transporter, there are no mother hooks/hangers, and that these mother hooks and hangers will be placed in the appropriate locations by the operator. When the transporter is properly positioned, the loading operation begins as described below.

As shown in FIG. 2A, on a surface of the panel 207 above the mother hook tray 512 of the transporter are the indicator lights, which are LED indicators 213 in this embodiment, that align with the mother hook slots 614. In the present embodiment, there are a total of thirty mother hook slots on the transporter and, as such, there are thirty corresponding LED indicators 213₁-213₃₀, each of which will reside adjacent to one of the mother hook slots 614. Each of the indicators 213 can be switched between three colors, green, yellow and red, which provides operator 200 with an indication of where a GOH item should be placed during loading of the transporter 110. In FIG. 2A, a solid white LED 213 represents those colored yellow, speckled shading indicates that an LED is colored red and a cross-hatched shading indicates that an LED is colored green. In the present embodiment, the portion of the panel 507 on which the indicator lights reside is slidably connected to the rest of the panel, and can be adjusted after the transporter 110 arrives so that the lights are correctly aligned with the mother hook slots 614 of the transporter.

When a GOH item is removed from an inbound conveyor and a mother hook and the item are scanned by the operator, as described above with regard to FIG. 2, the control system will illuminate one of the indicators 213 green, indicating in which mother hook slot the operator should place the mother hook and GOH item. In the example of FIG. 2A, the designated mother hook slot is that adjacent to LED 213₂₂. In the case of a relatively narrow item, such as a T-shirt, the width occupied by the garment would be sufficiently small that other GOH items could be placed in the immediately adjacent mother hook slots 614. However, since some GOH items may be much bulkier, such as a winter coat, it is sometimes necessary to allow more lateral space for the item, and the immediately adjacent mother slots are not used.

Such a situation is represented by the example shown in FIG. 2A, in which the designated mother hook slot has an LED (213₂₂) adjacent to it that is colored green. Because of the large lateral width of the item, which is known to the system once the item is scanned, a space equal to the width of five mother hooks is allotted and, to indicate to the operator that the two mother hook slots to either side of the designated slot are not to be used, the LEDs adjacent to those slots (i.e., LEDs 213₂₀, 213₂₁, 213₂₃ and 213₂₄) are illuminated red. After the mother hook with the scanned item is placed in the designated slot, the next item is scanned by the operator, and another slot is identified by illuminating an adjacent LED green (one outside of the range of those designated by LEDs 213₂₀-213₂₄). Depending on the width of the item, additional LEDs adjacent to the now green LED may be illuminated red to indicate that the mother hook slots adjacent to those LEDs should not be used.

The loading/unloading station 112, when used for unloading GOH items, involves the operator 200 removing GOH items from an arriving transporter 110. Referring to FIG. 2, a transporter 110 arriving at loading/unloading position 110a will be transporting GOH items to be sent to a packing station. The transporter will first stop at position 110b for a confirmation scan and, if the location 110a is currently occupied, will move to waiting area 110c. When it arrives at the position 110a, the operator 200 removes the GOH items without the mother hooks, and places them on the outbound conveyor or other system for delivering the garments to the packing station(s). Once all of the GOH items have been unloaded, the mother hooks are recovered by the operator and placed in a storage bin (not shown). Those skilled in the art will understand that there may be instances in which many of the unloaded garments are identical. In such a case, it may be more efficient for the operator to remove more than one GOH item from the transporter at the same time.

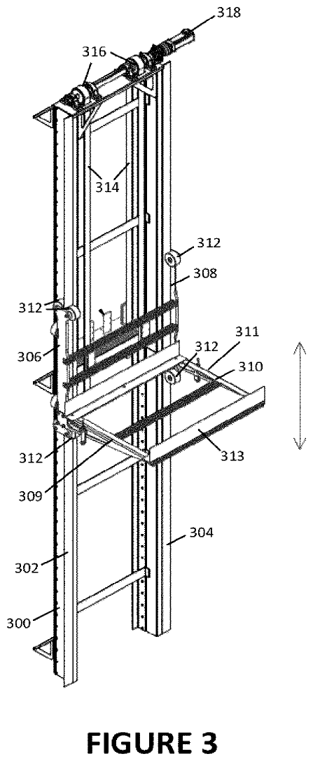

Referring again to FIG. 1, the storage area 100 may represent a single vertical level of a multi-level storage system. That is, the storage area 100 shown in the figure may be just the top level of the storage system, with other levels below it. In the exemplary embodiment, the different storage areas 100 of the different levels are all identically configured, but those skilled in the art will understand that levels with different configurations or layouts may also be used if so desired. To provide the transporters 110 and foragers 106 with access to the different levels, elevators adjacent to the x-aisle 108 of each level are accessible to the transporters 110 and foragers 106, and move them vertically up or down as necessary to bring them to the desired level. Elevators may also be placed next to one or more of the y-aisles if so desired. An example of an elevator 124 as used with the present embodiment is shown in FIG. 3.

The elevator of FIG. 3 consists of a vertical frame 300 having two side supports 302r, 304r toward a rear side of the elevator 124 and two side supports 302f, 304f toward a front side of the elevator, which together support the elevator structure. Movably attached to the side supports 302f, 304f are side brackets 306, 308 from which is suspended a support platform 310 having rails sized to receive a transporter 110 or forager 106. The side brackets 306, 308 are connected at the top by a top brace, and include wheels 312 at the top and bottom on opposing sides of lateral surfaces of the respective side supports 302f, 304f with which they are in contact. These wheels, which are not all visible in FIG. 3, provide a smooth movement of the platform 310 in the vertical direction relative to the side rails. Perpendicular wheels 313 are also included in the embodiment shown, and provide an additional low-friction contact between the side brackets 306, 308 to prevent binding while the platform 310 is being moved (although only the wheel 313 adjacent to side rail 304f is visible in FIG. 3, it will be understood that a corresponding wheel 313 is located in a symmetrical position adjacent to side rail 302f). An enlarged view of the arrangement of wheels 312, 313 is shown in FIG. 3A. The vertical position of the platform 310 is controlled by belts 314 that are attached to the platform 310 and that pass over pulleys 316 driven by a servo motor 318. An opposite end of each belt is attached to a counterweight 317 on the opposite side of the frame 300, which minimizes the power necessary to move the platform up and down.

The platform 310 is sized to receive a single vehicle (i.e., a transporter 110 or forager 106), and to move it vertically between different levels of the storage system. The elevator 124 is preferably oriented so that the lip 315 of platform 310 is facing the “y-direction” shown in FIG. 1 so that a transporter or forager on the elevator can directly enter from, or exit onto, the x aisle of a vertical level and, in the present embodiment, at a location aligned with one of the y aisles. The platform 310 is sized so that a vehicle can move entirely onto the platform 310, the rails of which align with the rails 111 adjacent to the elevator on any of the vertical levels to allow smooth movement of the vehicle between the elevator and the vertical level adjacent thereto. In the exemplary embodiment, a front side of the platform also has a lip 315 that may be raised pneumatically once the vehicle is fully on the platform. When raised, the lip 315 prevents a vehicle from accidentally rolling off of the platform 310. When a transporter or forager has been instructed to change levels, it will move to the elevator location (or to the location of a chosen one of the elevators if more than one is used). In the meantime, the system instructs the elevator to move the platform 310 to the proper level for receiving the vehicle. Once the servo motor 318 has positioned the elevator platform 310 at the proper level and the lip 315 is lowered, the vehicle is instructed to move onto the platform. With the vehicle on the platform 310, the elevator is then operated to move the platform to the desired level. Once it is properly in place, the lip 315 is lowered and the vehicle is instructed to disembark and to proceed to its next destination.

### Transportation

As discussed above, the autonomous vehicles used with the invention include the foragers 106 and the transporters 110. Both vehicle types require the capacity to move in two perpendicular directions, as they must be able to move along the y-aisles 104 and the x-aisles 108 of the storage system. Although these vehicles have different functions and different components mounted on them, in the exemplary embodiment they both use the same motorized base, referred to herein as a cart 400.

As mentioned above, the autonomous vehicles, and therefore the carts 400, move along a system of rails 111 that are installed on each level of the storage site. A partial section of this rail system 111 is shown in FIG. 2, and provides an understanding of how the rails 111 provide a fixed set of pathways that may be traveled by the vehicles. Each cart has a set of wheels for movement in a longitudinal direction, which corresponds to the y-direction shown in FIG. 1, and a separate set of wheels for movement in a transverse direction, which corresponds to the x-direction shown in FIG. 1. In the exemplary embodiment, the cart is rectangular in shape, and the distance from one side of the cart to the other between the wheels used for longitudinal movement is different than a corresponding distance between the wheels used for transverse movement. Thus, as shown in FIG. 2, the separation between the rails upon which the cart is riding is different depending on the travel direction.

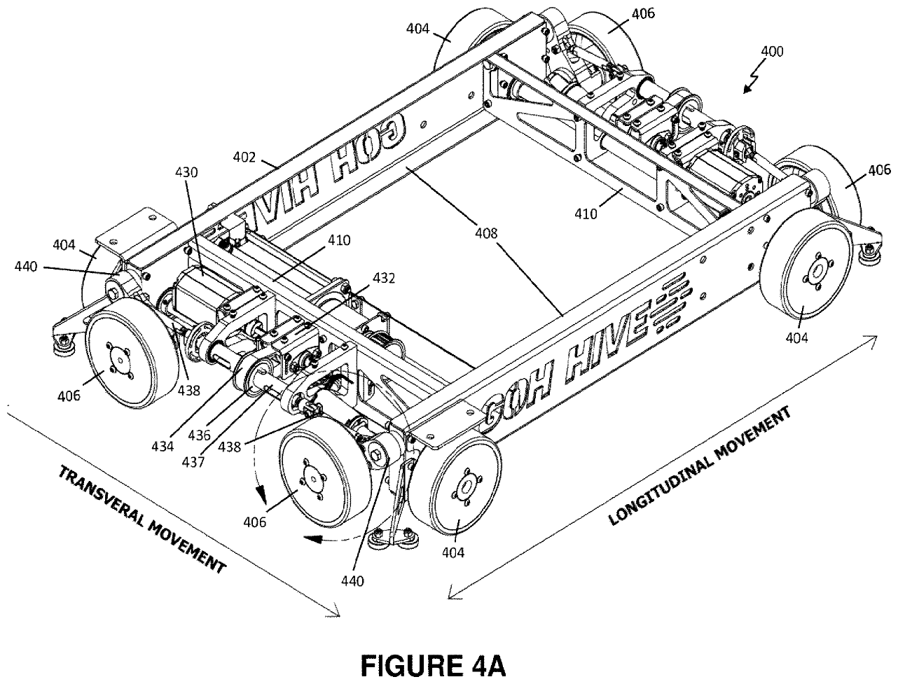

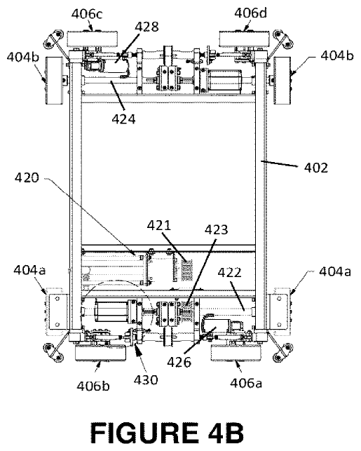

A perspective view of the cart 400 of the present embodiment is shown schematically in FIG. 4A. The cart 400 has a rectangular metal support frame 402 to which are attached four pairs of wheels 404, 406, two wheels being attached directly or indirectly to each side of the frame 402. Two parallel sides of the frame, referred to as the longitudinal sides 408, each have two wheels 404 attached directly to them. The four wheels 404 attached to the longitudinal sides of the frame 402 support the frame when the cart is moving in the longitudinal direction as shown in FIG. 4A. The two parallel sides of the frame 402 that are perpendicular to the longitudinal sides each have two wheels 406 attached to them, but these four wheels are attached indirectly via elevation mechanisms that allow them to be raised and lowered relative to the frame 402.

When the cart 400 is moving in the longitudinal direction indicated in FIG. 4A, the elevation mechanisms maintain the wheels 406 in a raised position, higher than the position of the wheels 404 relative to the frame 402. As such, the wheels 406 have no function during longitudinal movement. When the cart is to move in the transverse direction indicated in FIG. 4A, which is perpendicular to the longitudinal direction, the elevation mechanisms move the wheels 406 to a lowered position, lower than the position of the wheels 404 relative to the frame 402. Movement of the wheels 406 to the lowered position causes the frame 402 to be raised relative to the rails contacted by the wheels 404, thereby lifting the wheels 404 off the rails sufficiently that they remain above any portion of the rail structure that they must pass over. With the wheels 406 in the lower position, the cart 400 is therefore free to move in the transverse direction with the turning of the wheels 406, while the wheels 404, now elevated off the surface upon which the cart resides, have no function.

When the cart 400 resides on y-direction rails and movement in the transverse direction is desired, it is moved to a rail intersection with the wheels 406 positioned above a corresponding set of x-direction rails. The elevation mechanism used to lift and lower the wheels 406 includes a servo motor 430, the shaft of which is connected to a gearbox 432. The gearbox, in turn, drives a vertical gear rack 433 that is connected to lift carriage 435, to which wheels 406 are mounted. Thus, rotation of motor 430 in a first direction causes vertical movement downward of the gear rack 433, which moves the lift carriage 435 and wheels 406 down until they contact the x-direction rails underneath and lift the wheels 404 off the perpendicular y-direction rails. The cart may then move in the transverse direction along the x-direction rails. To change back to the y-direction, the cart is again positioned at an x-y rail intersection and the wheels 406 are raised by reversing the motor 430 until the wheels 404 are resting on the y-direction rails below the cart, and the wheels 406 are clear of the x-direction rails

The locomotion of the cart 400 is provided by a single electric motor that drives the wheels as necessary to move the cart in different directions. Power to the cart is provided by two 24V batteries 440, which are shown schematically in FIG. 4B, but are omitted from FIG. 4A for clarity. The batteries 440 are rechargeable, and battery chargers are connected directly to the rails on which the cart resides at designated charging locations within the rail system. Those skilled in the art will understand that a variety of different charging options are known in the prior art and can be used with the invention. The arrangement of the motor and drive components in the present embodiment is best shown in FIG. 4B, which is a top view of the structural core of the cart. For longitudinal movement, the wheels 404 shown in FIG. 4A are more specifically identified in FIG. 4B as motorized wheels 404a and idle wheels 404b. Electric drive motor 420 is mounted to the frame 402, and drives a drive pulley 421 attached to the shaft of motor 420, and a driveshaft pulley 423 attached to driveshaft 425. The two pulleys are linked by a belt 427, which transmits rotational energy from the motor shaft to driveshaft 425. The driveshaft connects to a gearbox 429 that translates rotation of the driveshaft 425 to rotation of the perpendicular axle 431, which is connected to wheels 404a. When the wheels 404 are in contact with the rails below the cart, the motion of the cart 400 in the longitudinal direction is therefore controllable via control of the drive motor 420. Idle wheels 404b are connected to axle 424, which spins freely relative to the frame 402, but is not under power.

The wheels 406 for transverse movement of the cart 400 are also shown in FIG. 4B, and are more specifically identified as motorized wheels 406a and idle wheels 406b. Unlike the motorized wheels 404a for longitudinal movement, which are driven via a gearbox, the motorized wheels 406a for transverse movement are driven via pulleys 437 attached to the driveshaft 425. These pulleys are each attached to a respective timing belt arrangement 439 which uses two timing belts mated with an intermediate pulley to drive a pulley fixed to a respective wheel 406a without slippage. Thus, when the wheels 406 are in contact with the x-direction rails below the cart, operation of the drive motor 420 will provide movement of the cart in the transverse direction. The wheels 406b are idle and, while they are moved up and down with wheels 406a, as described above, they simply follow the motion provided by the driven wheels.

In the exemplary embodiment, rotary encoders associated with the drive motors and/or wheels of the carts are used to track the positions of the carts relative to a fixed coordinate system in the operating space. Positions determined by the encoders can be compared to absolute positions confirmed using cameras and/or sensors that detect when the cart is at specific locations. This allows for compensation of minor positioning errors and calibration of the encoder positioning system. Those skilled in the art will recognize that other types of positioning systems may also be used, and those alternate embodiments are considered to be within the scope of the invention.

In the exemplary embodiment, the wheels 404, 406 of the cart ride in slots in the center of the rails 111, such that the cart follows a limited set of possible routes throughout the system site. The wheels may be narrower than the slots to minimize friction and, as best shown in FIG. 4A, guide wheels 405 are provided to keep the cart properly centered during movement. The guide wheels 405 are located at each corner of the cart 400, and are aligned with both the longitudinal wheels 404 and the transverse wheels 406. The guide wheels 405 have a perpendicular orientation relative to the wheels 404, 406, and have a vertical position that is high enough that they do not touch the bottom of the rail during either longitudinal or transverse motion of the cart, but low enough that they will make contact with an inner side of the rail before the wheels 404, 406 can make such contact. The guide wheels 405 are free to spin about a vertical axis, and therefore do not significantly impede the travel of the cart 400 when they touch the inner side walls of the rails. Thus, the guide wheels prevent the wheels 404, 406 from contacting the inner side walls of the rails while adding minimum frictional resistance.

Also shown in FIG. 4A are collision sensors 407 which, in the present embodiment, are LIDAR (“light detection and ranging”) sensors. Such sensors are known in the art and, by emitting optical signals and detecting reflections of those signals, can determine a distance between the sensor and a solid object located in front of it. The sensors 407 are positioned at the four corners of the frame 402 each facing a possible travel direction of the cart 400. The sensors are connected to the on-board communication system of the cart and provide a warning signal when an object is detected in the path the cart, allowing the control system to instruct the cart to stop before a collision occurs. Such an object might be another cart or it might be a GOH item that has inadvertently fallen onto the rails. The detection of such an item allows the system to be temporarily halted while the fallen item is retrieved.

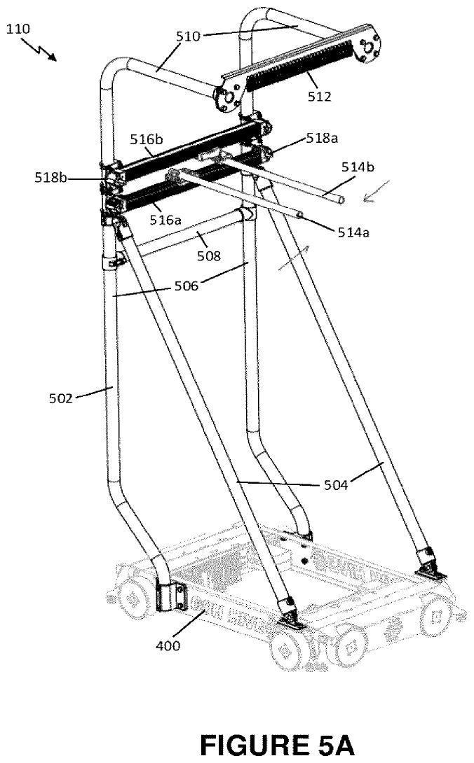

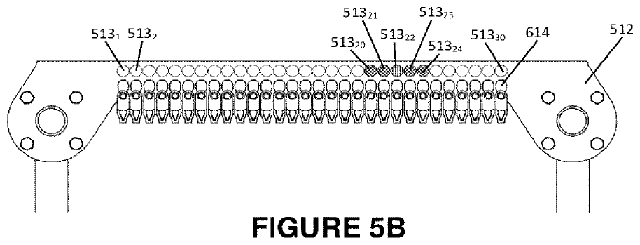

Shown in FIG. 5A is an exemplary embodiment of a transporter 110 according to the invention. The base of the transporter, which provides the necessary locomotion, is a cart 400, like that shown in FIGS. 4A and 4B, which is shown in broken lines in FIG. 5A for clarity. Fixed atop the cart is the structural frame 502 of the transporter, which provides the necessary structure for supporting the GOH items to be transported within the storage area. In this embodiment, the frame 502 includes two side members 503 connected to a base plate 505 which is, in turn, fixed to the cart 400. A top support 507 is mounted on the side members and includes, at a front side thereof, a mother hook tray 512 from which hangers 209 carrying the GOH items to be transported (not shown) are suspended. As discussed below, each of the transported items includes a hanger from which a garment, or another item such as a bag carrying a garment, is suspended, and a “mother hook” that provides a standardized connection between the hanger and the mother hook tray 512.

At the front of the transporter below the mother hook tray 512 are two pairs of horizontal compression bars 514a, 514b and 514c, 514d. The bars of each pair are parallel to each other and perpendicular to the mother hook tray 512. Each of the compression bars is mounted to a bracket connected to a motorized track that, when moved, results in a horizontal displacement of the compression bar to which it is connected. FIG. 5B shows an isolated view of the motorized tracks 516a, 516b for the compression bars 514a, 514b which are connected, respectively, to brackets 515a and 515b. Each bracket 515a, 515b can slide horizontally in its respective track 516a, 516b, and is driven by a respective servo motor 518a, 518b. The servo motors are each connected to a respective pulley about which is threaded a belt 519a, 519b to which the corresponding bracket 515a, 515b is fixed. Only pulley 517b is visible in FIG. 5B, but it will be understood that the pulley for motor 518a functions in the same manner. As the motor 518b rotates pulley 517b, belt 519b, which is a continuous loop, pulls bracket 515b in one direction or the other, depending on the direction of the motor rotation. An identical operation is used to move the bracket 515a, and thus the compression bar 514a, back and forth horizontally. Moreover, a second set of components identical to that shown in FIG. 5B is provided for control of the compression bars 514c, 514d, which are positioned lower on the transporter, as shown in FIG. 5A.

When the transporter 110 is ready to receive a new set of GOH items to be attached via mother hooks to mother hook tray 512, the compression bar servo motors are operated to move compression bars 514a, 514b apart from each other, and to move compression bars 514c, 514d apart from each other. This prevents any obstruction of the GOH items during loading. Once the desired GOH items are suspended from the mother hook tray 512, the servo motors 518a, 518b are operated to move the compression bars 514a, 514b back toward each other, thereby compressing an upper portion of the suspended garments between them. Similarly, the servo motors for compression bars 514c and 514d are operated to move those bars toward each other to compress a lower portion of the suspended garments The compression bars 514a, 514b, 514c, 514d remain in this position during transport to prevent movement of the suspended garments in response to inertial changes, which might otherwise cause one or more of the GOH items to become detached from the mother hook tray 512 or from a hanger from which it is suspended. The independent movement of each of the compression bars 514a, 514b, 514c, 514d allows the transporter to adapt to GOH items that may have different thicknesses closer to either the top or the bottom, or to GOH items that are not symmetrically distributed horizontally (such that a point equidistant between the bars at the optimum compression position is not centered relative to the transporter. In one version of this embodiment, curtains 521 are provided that are each vertically extendable between the compression bars on one respective side of the transporter 110 (one such curtain 521 is shown in broken lines in FIG. 5A between the compression bars 514a and 514c). The curtains 521 provide additional protection against garments moving outside of the vertical profile of the transporter 110 as it moves, and may be retracted or extended to suit the particular application.

A rear perspective view of the mother hook tray 512 of transporter 110 is shown in FIG. 5C. A servo motor 523 mounted to the mother hook tray 512 is connected via a pulley and belt to a passive pulley on a locking camshaft 525 that is used to lock the mother hooks 600 in place when they are positioned in the mother hook tray 512. Thus, when the servo motor 523 rotates the camshaft 525 into the locked position shown in the side view of FIG. 5D, a cam attached thereto makes contact with the top of each of the mother hooks 600, preventing them from becoming dislodged from the mother hook tray 512. When the GOH items are to be removed from the mother hook tray 512, the servo motor 523 is rotated to the unlocked position, as shown in the side view of FIG. 5E, and the mother hooks are no longer locked in place.

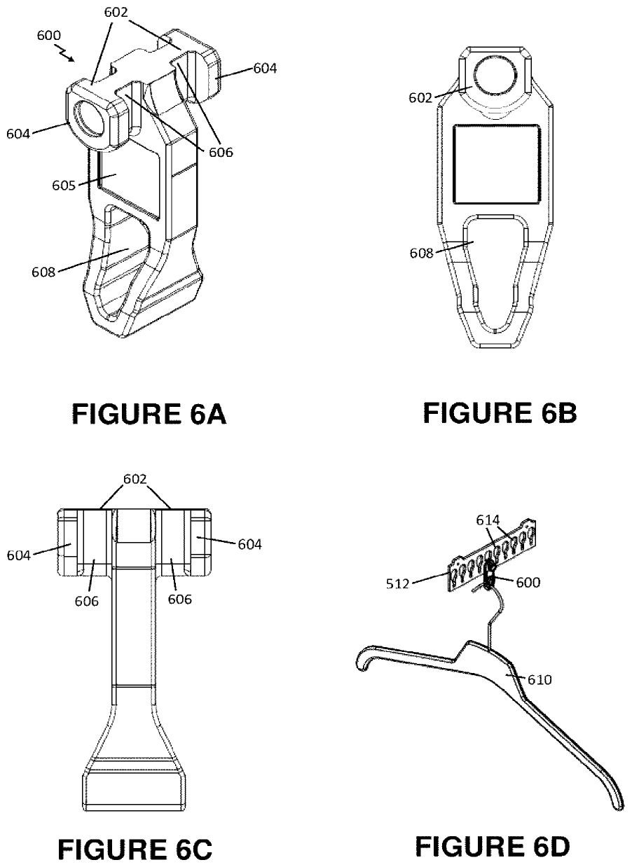

FIG. 6A is a perspective view of a mother hook 600 used with an exemplary embodiment of the invention. FIGS. 6B and 6C show, respectively, front and side views of the mother hook. The mother hook functions as a standardized connector that can be easily loaded and unloaded on transporters 110 or in storage locations. The mother hook 600 has a reflection symmetry about a vertical plane passing through its center, as evident from the side view of FIG. 6C, and it is therefore reversible. Projecting from either side of the mother hook are mounting studs 602 that may be secured by a mechanical component, and that are used to removably attach the mother hook to a mounting site, either at a storage location or on a transporter. Each mounting stud 602 has a protruding head 604 secured to a main body of the mother hook 600 by a standoff 606 that is narrower than the head 604 in a horizontal direction allowing the head to secure the mother hook to a mounting site when inserted into a retaining slot, as discussed further below. Below the mounting stud 602 is a flat region 605 on which may be displayed a barcode attached, for example, by an adhesive label. An RFID tag may also be attached to the mother hook if so desired.

Near the base of the mother hook 600 is aperture 608, which receives the top of the garment hanger of a GOH item to be stored or transported. The aperture 608 has an upper region that is relatively wide for facilitating acceptance a hanger hook inserted therein. Once inserted, the hanger hook descends to a narrower portion of the aperture 608 near the base of the mother hook 600, which aligns the hanger and corresponding GOH item with a vertical center line of the mother hook. The narrow section at that base of the teardrop-shaped aperture 608 also minimizes rotation of the GOH item relative to the mother hook.

Shown in FIG. 6D is a partial view of the mother hook tray 512 with a mother hook 600 from which a hanger 209 is suspended. Those skilled in the art will understand that, in ordinary practice, the hanger 209 would be supporting a garment, or other item, to be transported/stored but, for clarity, the figure shows only the hanger. In this example, the mother hook 600 is inserted and secured in a corresponding slot of mother hook tray 512. The mother hook tray 512 has a number of keyhole shaped slots 614, each sized to receive the mounting stud of a mother hook. After the mounting stud is inserted into a corresponding slot 614, the mother hook 600 may either be moved downward, or allowed to descend by force of gravity to the position shown in FIG. 6D. Since the lower portion of the slot 614 is narrower than the head 604 of the mounting stud, but wide enough to accommodate the standoff 606, the mother hook 600 is securely retained therein. A mother hook tray 512 like that depicted in the figure may be located on a transporter (as shown in FIG. 5), or in a storage location, although storage locations may also use different types of racks with similar slots. It will be understood that the mother hook tray 512 shown is just one example, and other sizes, shapes and configurations may be used to provide support for GOH items.

### GOH Handling

A forager 106 according to an exemplary embodiment of the invention performs the automated storage and retrieval functions of the system, either picking (removing) GOH items from a transporter 110 and placing them in a designated storage location, or picking garments from a storage location and placing them on a transporter 110 or in a different storage location. In this embodiment, the forager 106 has a mobile base in the form of a cart 400, as described above, which allows it to move throughout the storage area. Although the forager 106 is therefore capable of the same range of locomotion as the transporters, in the present embodiment, the movement of each forager is typically limited to a designated region of the storage area. The foragers 106 instead work in conjunction with the transporters to provide the necessary system operation.

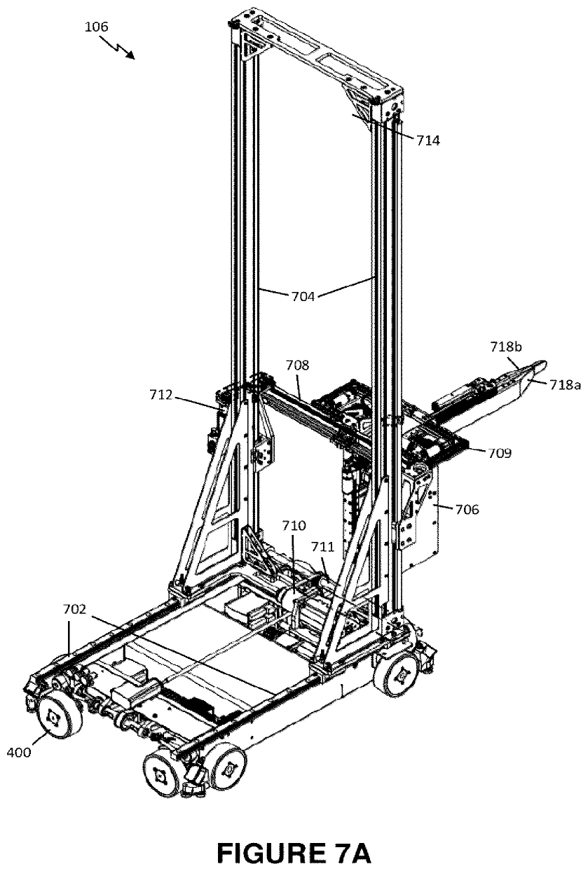

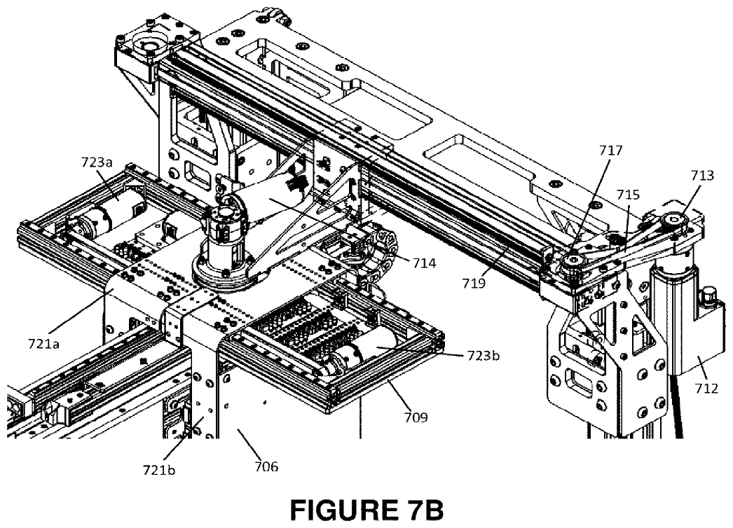

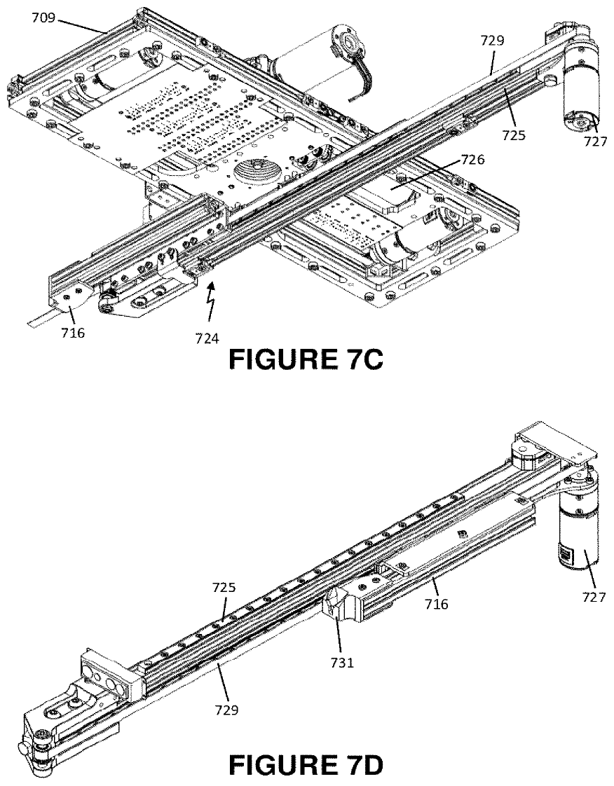

FIG. 7A shows a forager according to the invention in a forward position on its cart 400, such that a movable head 706 extends beyond the horizontal extent of the cart 400. The forager 106 has a support frame atop the cart 400 that includes rigid, horizontal base supports 702 that are connected to rigid, vertical supports 704 that provide an elevated structure for supporting the movable head 706. As discussed below, the support frame is constructed to allow the vertical supports, and therefore the head 706, to move longitudinally back and forth along the base connected to the cart 400. The head 706 itself is capable of movement horizontally and vertically, and can rotate about an angle of 180°. It includes two halves that can be separated from each other in a horizontal direction perpendicular to their common direction of vertical movement. The components of the head can reach for and retrieve GOH items from different directions, can reorient them and can move them towards a transporter or extend them toward a storage area to deposit the items accordingly.

FIG. 7B shows the forager 106 with the cart omitted from the drawing for clarity. In the figure, the vertical portion is at the opposite end of the base then in the view of FIG. 7A, showing base drive motor 705 and vertical drive motor 710. The vertical supports 704 are slidably fixed to the base supports 702, and the relative horizontal position of the vertical supports relative to the base supports is controlled by operation of the base drive motor 705, which turns an axle connected to pulleys (not shown) on which are threaded closed loop base belts 707. The base belts are looped around respective idle pulleys at the opposite end of the base from the drive pulleys connected to the axle of the base drive motor, and are each fixed to the vertical support structure such that rotation of the base drive motor moves the base belts and, correspondingly, the vertical structure. This allows control of the position of the vertical structure relative to the base supports 702 and the cart to which they are fixed.

The head 706 is movably attached to a cross member 708 that has two spaced-apart horizontal bars and that is, itself, attached at each end to a respective drive belt 715 mounted adjacent to one of the vertical supports 704 (only one of the drive belts 715 is visible in FIG. 7B). Each drive belt 715 forms a closed loop, being retained by a passive pulley near the top of the adjacent vertical support 704 and a drive pulley 717 at the bottom of the vertical support. Vertical drive motor 710 turns an axle 711 via a drive belt, the axle being connected to the two lower drive pulleys 717 such that, when energized, the motor 710 causes rotation of the pulleys and a corresponding movement of each belt. As the cross member 708 is connected to the two drive belts, it therefore moves up and down in response to operation of the motor 710. A counterweight 703 is also connected to the two belts on an opposite side of the passive pulleys near the top of the vertical supports 704, and balances the weight of the head 706 so as to minimize the energy necessary for its vertical movement.

As mentioned above, the head 706 is also movable horizontally relative to the cross member 708. This is shown more clearly in the detailed partial perspective view of FIG. 7C and the partial front view of FIG. 7D. Horizontal drive motor 712 turns a drive pulley 713 connected by a lateral belt 719 that forms a closed loop between the drive pulley 713 and a passive pulley at the opposite end of the cross member 708. The head is slidably connected to the cross member 708, and is attached to one contact point on the lateral belt 719. Thus, operation of the horizontal drive motor 712 results in movement of the lateral belt and a corresponding lateral movement of the head 706.

In order to provide the forager 106 with the ability to interact with items on its two lateral sides, the head 706 can also rotate 180° about a vertical axis. Rotational drive motor 714 is mounted on a support that connects the head 706 to the cross bar 708, and has a rotor attached to a mounting bracket 709 of the head 706. Operation of the motor causes a rotation of the mounting bracket 709, and therefore the head, relative to the forager frame. Thus, without the entire forager rotating, the tools attached to the head 706 can face any of the horizontal directions within the rotational range. A camera 722 is mounted to the head 706 and faces a forward operating direction of the head directly in line with the mechanism for manipulating GOH items, as is discussed further below. The camera allows for verification of the presence of a mother hook at a specific slot.

The head 706 also has two portions 721a, 721b that can move apart from each other relative to a center point on the head. The separation of these two portions allows two blades 718a, 718b that extend from the head portions 721a, 721b to be separated from each other, as discussed in more detail below. Each of the portions 721a, 721b is connected to a belt driven by a respective servo motor 723a, 723b, such that rotation of the respective motor shaft in one direction or the other results in a corresponding movement of the connected portion 721a, 721b relative to a center point of the head 706. In this way, the blades 718a, 718b can be moved apart from each other and back together again. The blades 718a, 718b are themselves movably connected to their respective side portions 721a, 721b, allowing them to move vertically relative thereto. This is discussed in more detail below in conjunction with FIG. 7G

FIG. 7E is a perspective view of an underside of the bracket 709 of head 706. The side portions 721a, 721b and blades 718a, 718b are omitted from this view for clarity. As shown, attached to the underside of the frame is a picker arm mechanism 724 that includes picker arm 725 that may be extended and retracted relative to the head 706. The picker arm 725 is slidably connected to the bracket 709 by support rails. A mechanism for moving the picker arm 725 relative to the bracket 709 is located within a housing of the bracket and is not shown in the figures. In the exemplary embodiment, the mechanism includes a picker support servo motor 726 (shown in FIG. 7C) that is rigidly fixed to bracket 709 and that, when operated, rotates a set of pulleys through which a belt passes that is fixed to the longitudinal ends of the picker arm 725. That is, one end of the belt connects to the proximal end of picker arm 725, while the other connects to the distal end. Thus, when the picker support servo motor rotates the connected pulleys, it causes picker arm 725 to slide in one direction or the other relative to the bracket 709. This allows the picker arm to be moved back and forth relative to the head 706. In the exemplary embodiment, the picker arm also includes a proximity sensor 728 that provides a signal output when the sensor makes contact with a rack or mother hook tray, thus allowing for accurate positioning of the end of the picker arm. Those skilled in the art will understand that other types of mechanisms may also be used for controlling movement of the picker arm relative to the bracket 709.

A picker arm extension 716 is also shown in FIG. 7E, and supports a receptacle for capturing a mother hook to which a GOH item may be suspended. A picker extension servo motor 727 has a shaft connected to a pulley that supports a closed loop belt 729 that extends along the length of the picker arm 725, and that is connected to the picker arm extension 716 at one point along its length. Thus, rotation of the servo motor 727 causes movement of the belt 729 and, correspondingly, movement of the picker arm extension 716 parallel to the picker arm 725. Movement of picker arm 725 and picker arm extension 716 thereby permits accessing positions at which a GOH item is to be picked or placed.

FIG. 7F shows a perspective view of an upper side of the picker arm 725 and picker arm extension 716, with the picker arm extension in a retracted position, near a proximal end of the picker arm 725. At the distal end of the picker arm extension 716 is mother hook receptacle 731, which has a hollow space that can receive either of the heads 604 of a mother hook 600. A front wall of the receptacle has a slot that tapers inward in a downward direction, a lower section of the slot being sized to accept the width of the standoff 606 of a mother hook. Thus, when the head of a mother hook with a GOH item attached resides in the hollow space of the receptacle 731, it will be retained therein, allowing the forager 106 to move the GOH item by moving the picker arm 725/picker arm extension 716, the forager head 706 and/or the forager itself.

While the vertical position of the picker arm 725 is controlled by the vertical positioning of the head 706, the blades 718a, 718b are provided with independent vertical movement relative to the side portions 721a, 721b. FIG. 7G shows blade 718b slidably connected to side portion 721b, and it is free to move within a limited vertical range relative to the side portion 721b. Blade motor 733b is mounted on the side portion 721b, and turns drive pulley 735b about which is looped drive belt 737b, which is also looped around idle pulley 739b at the lower end of side portion 721b so as to form a closed loop. Since the blade 718b is connected at one point to the belt 737b, rotation of the motor 733b causes movement of the belt 737b relative to side portion 721b and a corresponding vertical movement of the blade 718b. A similar arrangement is provided for side portion 721a and blade 718a to allow independent vertical movement of that blade as well. The ability to move the blades 718a, 718b vertically relative to the side portions 721a, 721b allows for manipulation of a GOH item by the picker arm 725 with minimal interference from surrounding GOH items, as described further below.

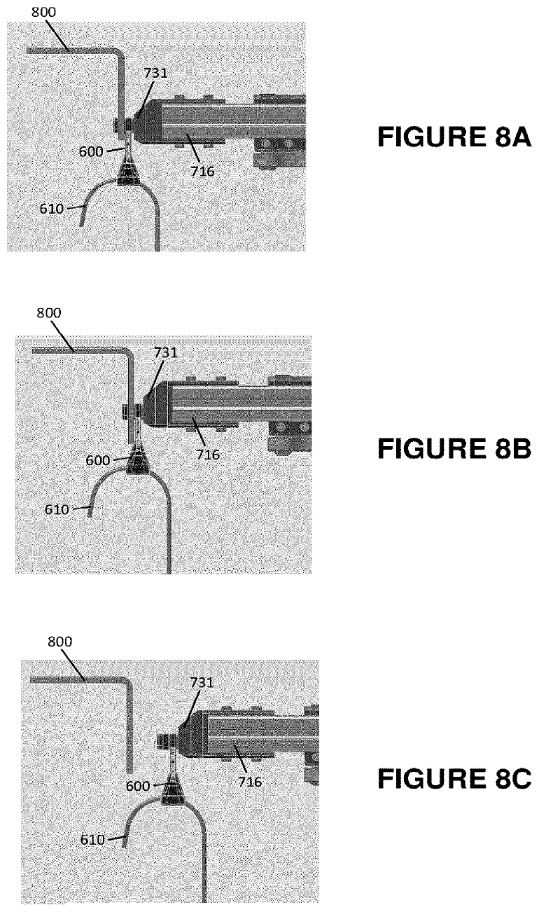

FIGS. 8A-8E show the manner in which the picker arm picks or places a GOH item in a desired location, either in a storage area or on the mother hook tray 512 of a transporter 110. In FIG. 8A, a mother hook 600 with the hanger 209 of a GOH item suspended from it is in a slotted rack 800 (which may correspond to the mother hook tray of a transporter or to a rack of a storage location in a storage area). The rack 800 retains the mother hook 600 with the head 604 of one of the mounting studs 602 residing in a slot which, as shown in the mother hook tray 512 of FIG. 6D, is wide enough in an upper region thereof to receive the head 604, and narrower in a lower region such that the standoff 606 of the mother hook fits within the lower region, while the head 604 resides on the opposite side of the rack 800 from the rest of the mother hook 600.

In FIG. 8A, the picker arm is shown extending toward the rack 800, but not yet in contact with it. The position of the proximity sensor 728 is somewhat exaggerated relative to FIG. 7F, as it would otherwise be hidden from view, but those skilled in the art will understand that the exact location of the proximity sensor 728 may vary according to the application, provided that it is positioned to contact the rack before any other portion of the picker arm. FIG. 8B shows a second position in the picking sequence in which the proximity sensor 728 has made contact with the rack 800, and the signal it outputs is used to stop the advancement of the picker arm. At this point, the picker arm extension 716 is advanced along the picker arm with receptacle 731 at a vertical position just below the vertical position of the mother hook head 604 on the side of the mother hook facing the picker arm 725. When the picker arm extension makes contact with the rack 800, the picker arm is then raised in a vertical direction so that receptacle 731 receives the outward facing mother hook head 604, as shown in FIG. 8C. In the present embodiment, the picker arm extension 716 is spring loaded by an internal spring that is compressed as the extension makes contact with the rack 800. This spring-loading prevents collision damage, while maintaining positive contact between the receptacle 731 and the rack. With the mother hook head 604 captured by the receptacle, the picker arm may manipulate the mother hook 600 and, correspondingly, the GOH item. However, the mother hook must still be released from the storage rack 800.

In FIG. 8D, the picker arm extension 716 has been raised relative to the storage rack 800 so that the mother hook head 604 on the opposite side of the rack 800 is now at the vertical level of the wider portion of the slot in which the mother hook resides. Since the mother hook head 604 may pass through this wider portion, the mother hook 600 may be withdrawn from the storage rack. This next step of the retrieval process is shown in FIG. 8E, in which the picker arm extension 716 has been retracted along the picker arm together with the mother hook 600 and hanger 209.

When the forager 106 has control of a GOH item, it may place the item in a desired location by a series of steps somewhat opposite those shown in FIGS. 8A-8E. With picker arm extension 716 holding a mother hook 600 in its receptacle 731 (as shown in FIG. 8E), the picker arm is positioned with the mother hook aligned horizontally and vertically with the wider portion of a slot on a storage rack 800. The picker arm is then extended until the proximity sensor 728 makes contact with the rack. From this position, the picker arm extension 716 may be moved to insert the mother hook head 604 on the side of the mother hook away from the picker arm into the wide portion of the slot, as shown in FIG. 8D. In order to secure the mother hook 600 to the rack 800, the picker arm is then lowered vertically so that the mother hook descends in the slot with the mother hook head that passed through the slot remaining on the side of the rack 800 opposite the picker arm 725. Since the standoff 606 of the mother hook 600 is narrow enough to fit in the narrower portion on the lower side of the slot, the mother hook 600 will descend to the bottom of the slot, while the mother hook head 604 obstructs further lateral motion of the mother hook 600. The mother hook 600 and picker arm extension 716 are then in the position shown in FIG. 8C. From this position, the picker arm extension 716 may be lowered further, until the mother hook head 604 on the picker arm side of the rack 800 exits the receptacle 731, and the mother hook 600 and attached GOH item are retained in the desired storage position on the rack 800. The picker arm 725 may then be retracted, as shown in FIGS. 8B and 8A, and the forager 106 may proceed to the next task.

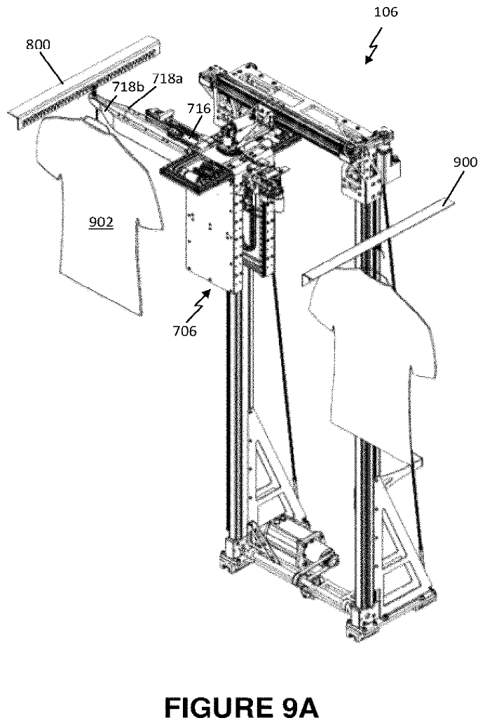

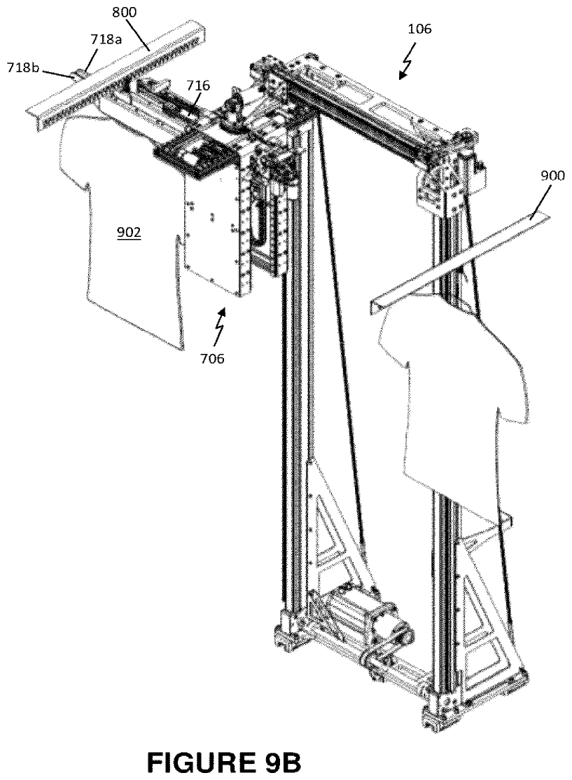

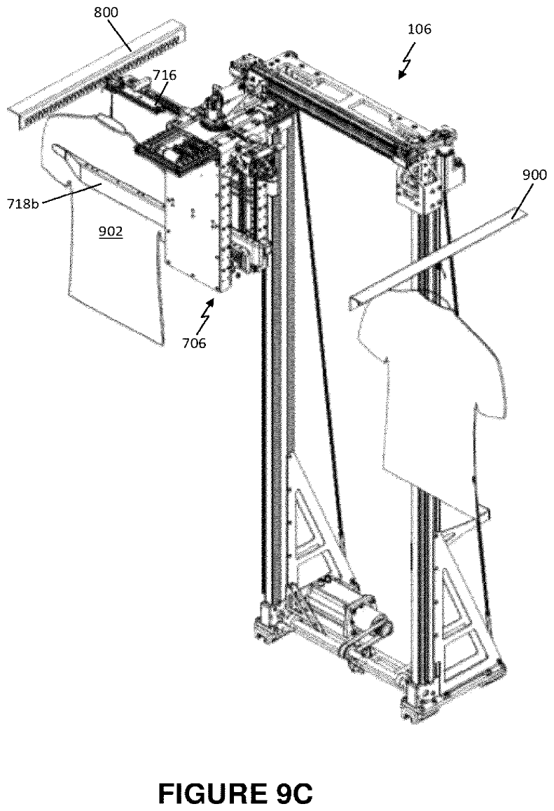

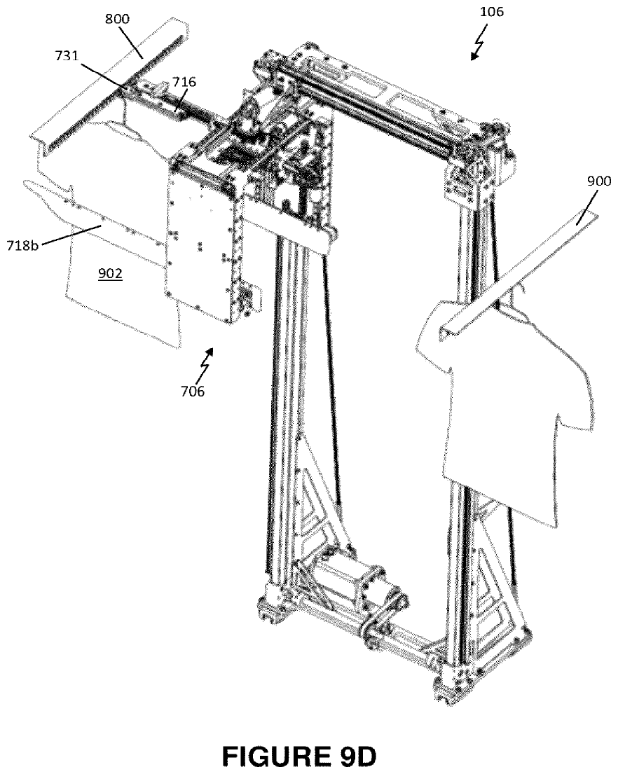

When picking or placing a GOH item, whether stored on a storage rack 800 in a storage area or on the mother hook tray of a transporter 110, it may be desirable to avoid inadvertent contact with adjacent GOH items, which might otherwise disturb the process, or even cause an item to fall to the ground. The forager blades 718a, 718b are therefore used to gently move aside adjacent items to temporarily increase the space available for the picking or placing operation. FIG. 7B, discussed above, shows the upper portion of the forager 106 (i.e., with the cart 400 not shown) in the process of picking an item from a storage rack 800. In this figure, the storage rack 800 holds a GOH item 902 (in this case, a T-shirt on a hanger) that is to be picked by the forager. For clarity, adjacent GOH items suspended from the rack 800 are not shown, but it will be understood that the entire rack 800 may be filled with GOH items, some of which are immediately adjacent to the GOH item 902. The additional steps in the picking sequence are shown in FIGS. 9A-9C.

In the position shown in FIG. 7B, the forager has rotated the head 706 so that the blades 718a, 718b are facing the rack 800, and has adjusted the position of the head so that the distal ends of the blades are laterally aligned with the location of the mother hook 600 from which the GOH item 902 is suspended. The blades are close to each other, but have a relative separation that is wider than a predetermined thickness of the GOH item 902. The forager head 706, and therefore the blades 718a, 718b, are then moved in the direction of the rack 800 until the distal ends of the blades are significantly past the location of the mother hook 600. This is the position of the forager 110 as shown in FIG. 9A.

In FIG. 9A, it can be seen that the blades 718a, 718b are to either side of the GOH item 902, and that they extend across most or all of the width of the GOH item. At this point it time, the picker arm extension 716 of the forager 106 may approach the rack to begin the process of attaching the picker arm receptacle to the mother hook 600 from which GOH item 902 is suspended. From this position, the blades 718a, 718b are lowered in a vertical direction relative to their respective side portions 721a, 721b, as shown in FIG. 9B, such that each blade is positioned on either side of the GOH item 902. As mentioned above, the blades 718a, 718b are preferably closely adjacent to the GOH item 902, but not close enough to create any significant force of friction that might dislodge the GOH item 902. Similarly, the position of each blade may be necessarily close to a GOH item immediately adjacent to the GOH item 902, but not so close that any significant friction is generated. The picking process also continues as the picking arm extension 716 continues to establish a positive engagement with the mother hook supporting GOH item 902.

Once the blades 718a, 718b have descended to a predetermined vertical position, which may be to the bottom range of the blades relative to the side portions 721a, 721b, the side portions are moved away from each other horizontally so that the blades are separated from each other in the lateral direction. That is, blade 718a moves in one direction away from a center of the head, while blade 718b moves in the other direction away from the center of the head. This relative motion of the blades causes them to push, respectively, on the GOH items residing adjacent to GOH item 902, such that those items pivot away from GOH item 902. That is, while the mother hooks of the adjacent items remain in place in the slots adjacent to the slot in which the mother hook of GOH item 902 is located, the items themselves are moved away from GOH item 902 to create more space for the picker arm extension 716 to retrieve it without interference from the adjacent items.

As shown in FIG. 9C, the picker arm/picker arm extension has continued the picking process while the blades have descended and separated the adjacent GOH items, and receptacle 731 has engaged the mother hook 600 of GOH item 902 as shown in FIG. 8A. The item may thus be retrieved by the picking arm as described above without interference from the adjacent GOH items. Once GOH item 902 is clear of the other GOH items on rack 800, the blades move back together in the lateral direction, and are retracted away from the rack. The forager may then be operated to place GOH item 902 on the mother hook tray 512 of a transporter 110 or, if so desired, in another storage location. In a system configuration like that shown in FIG. 1, a separate storage rack would typically be located to an opposite side of the forager 106, and those skilled in the art will understand that this storage rack would also be accessible to the forager by its rotating the forager head 706 by 180°. Similarly, a 90° rotation would typically be used to access a transporter 106 that was positioned adjacent to the forager 106 on an y-aisle of the storage location.

The process of placing a GOH item is similar to that described above with regard to FIGS. 7B and 9A-9C, except that the GOH item 902 is being held by the picker arm extension 716 at the start of the sequence. Once the desired storage location is identified, the forager 106 positions itself with the picker arm facing the intended storage location, and with the blades 718a, 718b to either side of it. The blades are then extended as in the picking process so that they are between the GOH items immediately adjacent to the desired storage location. The blades then descend, as described above, and move away from each other so that the adjacent garments are moved away from the intended storage location for GOH item 902. The picking arm extension 716 may then move the mother hook 600 of GOH item 902 into the desired slot on the rack, descend until it is free of the mother hook, and then withdraw, leaving the GOH item 902 at the intended storage location on the rack. The blades then move closer together, and are withdrawn from the spaces between the GOH items.

During the picking and placing operations discussed above, the camera 722 (as shown, for example, in FIG. 7B) is used to align the picking arm 725 and blades 718a, 718b relative to the storage rack 800 or the mother hook tray 512 of the transporter 110. As mentioned above, a series of visual indicators may be used to simplify the identification of correct position on the rack or mother hook tray. In the embodiment shown in FIG. 7B, an alternating sequence of triangles and plus sign symbols are arranged above the mother hook slots of the storage rack 800, and these symbols allow the camera control system to quickly and easily orient itself, and therefore the head 706, relative to the rack.

1. An automated storage and retrieval system for managing the contents of a storage area in which garment-on-hanger (GOH) items are stored, the system comprising:
an autonomous transport vehicle that is configured for automated movement between a processing location away from the storage area and a predetermined region of the storage area, and that transports GOH items between the processing area and the storage area; and
an automated storage/retrieval apparatus that is configured to hold and manipulate a GOH item, and that is configured to place a GOH item transported from the processing area in any of a plurality of designated storage locations of the storage area, and/or to retrieve a GOH item from any of a plurality of designated storage locations in the storage area to be subsequently transported to the processing area.

2. The system of claim 1 wherein the storage/retrieval apparatus and the transport vehicle are separate apparatuses.

3. The system of claim 1 wherein the storage/retrieval apparatus is configured to remove GOH items from the transport vehicle and place them in the designated storage locations, and/or to remove GOH items from the designated storage locations and place them on the transport vehicle.

4. (canceled)

5. The system of claim 1 wherein the storage area has multiple vertical levels with designated storage locations on each level, and wherein the system further comprises an elevator that can support the transport vehicle or the storage/retrieval apparatus, and that is configured to move at least one of the transport vehicle and the storage/retrieval apparatus between said vertical levels.

6. (canceled)

7. The system of claim 1 further comprising a plurality of standardized mounting hooks from which the hangers of the GOH items are suspended, wherein the storage/retrieval apparatus holds the GOH items by the mounting hooks.

8-9. (canceled)

10. The system of claim 1 wherein the transport vehicle has a battery and a wheeled base powered by at least one electric motor.

11. The system of claim 1 wherein the storage/retrieval apparatus is an autonomous vehicle capable of independent movement.

12. (canceled)

13. The system of claim 1 wherein the storage/retrieval apparatus comprises a head from which extends a picker arm with which a GOH item is held and manipulated.

14-17. (canceled)

18. The system of claim 13 further comprising a plurality of blades that extend from the head of the storage/retrieval apparatus, the blades being movable relative to each other in a horizontal direction such that the blades may be inserted to either side of a first of said designated storage locations and moved apart from each other so as to displace GOH items stored in designated storage locations to either side of said first designated storage location prior to placing a GOH item in the first designated storage location or retrieving a GOH item from the first designated storage location.

19-22. (canceled)

23. The system of claim 1 further comprising a system of rails distributed throughout the storage area upon which the transport vehicle travels.

24-25. (canceled)

26. An automated storage/retrieval apparatus that can hold and manipulate a garment-on-hanger (GOH) item supported by a mounting hook, the apparatus comprising:
a base and a support frame mounted to and extending vertically from the base;
a head mounted to the support frame, the head being rotatable through a predetermined rotation range relative to the base and being vertically displaceable relative to the base and horizontally displaceable relative to the support frame; and
a picker arm mounted to the head that is extendible along a horizontal plane, the picker arm having a receptacle configured to capture the mounting hook such that the hook and GOH item may be held by the picker arm and displaced by movement of any of the picker arm, the head and the base.

27. The apparatus of claim 26 wherein the base is a wheeled base powered by at least one electric motor by which the apparatus can move autonomously within a designated area.

28. The apparatus of claim 26 further comprising a pair plurality of blades that extend from the head, the blades being movable relative to each other in a horizontal direction such that the blades may be inserted to either side of a first designated storage location at which the GOH item is located and moved apart from each other so as to displace any GOH items stored in designated storage locations to either side of said first designated storage location prior to placing a GOH item in the first designated storage location or retrieving a GOH item from the first designated storage location.

29-31. (canceled)

32. An autonomous transport vehicle for use in a storage area in which garment-on-hanger (GOH) items are stored, the transport vehicle comprising:
a wheeled base powered by at least one electric motor by which the transport vehicle can move autonomously throughout the storage area;
a support frame mounted to and extending vertically from the base;
a mounting hook tray attached to the support frame from which the GOH items may be suspended; and
a plurality of compression bars attached to the support frame that extend horizontally therefrom such that GOH items suspended from the mounting hook tray are located between the compression bars, the compression bars being horizontally movable relative to each other to compress the GOH items between them and limit any inertial movement thereof during transport.

33-35. (canceled)

36. The transport vehicle of claim 32 further comprising a plurality of standardized mounting hooks that are removably secured to the mounting hook tray and from which the hangers of the GOH items are suspended, wherein the storage/retrieval apparatus holds the GOH items by the mounting hooks.

37. A method for storing garment-on-hanger (GOH) items in a storage area using an automated storage and retrieval system according to claim 1, the method comprising:
loading the GOH items at a processing location away from the storage area onto the autonomous transport vehicle;
transporting the GOH items with the autonomous transport vehicle from the processing location to the predetermined region of the storage area;
removing the GOH items from the autonomous transport vehicle with the automated storage/retrieval apparatus; and
placing, with the automated storage/retrieval apparatus, the GOH items removed from the autonomous transport vehicle in any of said plurality of designated storage locations of the storage area.

38-42. (canceled)

43. The method of claim 37 wherein the storage/retrieval apparatus is an autonomous vehicle capable of independent movement.

44. (canceled)

45. The method of claim 37 wherein removing the GOH items from the autonomous transport vehicle and placing the GOH items in a designated storage location comprises holding and manipulating the GOH items with a picker arm mounted on a head of the storage/retrieval apparatus.

46-48. (canceled)

49. The method of claim 45 wherein the GOH items are suspended by standardized mounting hooks and wherein holding and manipulating the GOH items comprises capturing one of said mounting hooks with a receptacle at a distal end of the picker arm.

50. The method of claim 37 wherein the storage/retrieval apparatus comprises a pair plurality of blades that are movable relative to each other in a horizontal direction and wherein placing the GOH items further comprises inserting the blades to either side of a first of said designated storage locations and moving the blades apart from each other so as to displace GOH items stored in designated storage locations to either side of said first designated storage location prior to placing a GOH item in the first designated storage location.

51-53. (canceled)

54. The method of claim 37 wherein transporting the GOH items with the autonomous transport vehicle comprises moving the transport vehicle along a system of rails distributed throughout the storage area.

55. A method for retrieving garment-on-hanger (GOH) items from a designated storage area using an automated storage and retrieval system according to claim 1, the method comprising:
removing the GOH items from the designated storage area with the automated storage/retrieval apparatus;
placing, with the automated storage/retrieval apparatus, the GOH items removed from the designated storage area on the autonomous transport vehicle;
transporting the GOH items with the autonomous transport vehicle from the designated storage area to the processing location; and
unloading the GOH items from the transport vehicle at the processing location.
